(19) United States
(12) Patent Application Publication
(10) Pub. No.: US 2012/0281757 A1
(43) Pub. Date: Nov. 8, 2012

(54) Scene change detection for video transmission system

(76) Inventors: Francisco J. Roncero Izquierdo, Leganes (ES); Alberto Duenas, Mountain View, CA (US)

(21) Appl. No.: 13/067,049

(22) Filed: May 4, 2011

(51) Int. Cl. H04N 7/32

(52) U.S. Cl. 375/240.13; 375/E07.243

(57) ABSTRACT

A video transmission system includes an encoder and a decoder. As video data is encoded, the system uses temporal or spatial prediction to reduce the number of bits needed to encode frames. An increase in the complexity of the data results when a scene change occurs. The scene change is detected for intra-frame and inter-frame frames by monitoring statistics for the macroblocks within the current frame. Once the scene change is detected, the encoder or the system takes actions to prevent latency, bit rate fluctuation or quality degradation for the video transmission.

### FIELD OF THE INVENTION

The present invention relates to transferring video signals over a network. More particularly, the present invention relates to detecting a scene change within the video signal transmission to minimize possible quality degradation due to system constraints.

### DISCUSSION OF THE RELATED ART

Before transmitting video content over a network, a video frame is compressed using an algorithm to encode the data. Some of these algorithms may be complex and the amount of data significant. For a defined video compression system, the necessary bit rate to achieve a specific video quality may depend on the complexity of the image being encoded. Complex images may require a higher bit rate for encoding.

To reduce the amount of data to encode, known video transmission systems may use prediction processes to re-use parts of an image already available. Known systems may use temporal prediction or spatial prediction to reduce the data rate needed to transmit video signals. Intra-frame prediction may be spatially while inter-frame prediction may use both temporal and spatial methods.

Further, rate control of the encoding process for the video transmission system may constrain changes in the complexity of the incoming video. Statistics from the previous frame having a same type of the current frame are used by the rate control to set the appropriate compression ratio for the current frame. As well as a target constant bit rate and the latency requirements, a rate control objective is to try to keep quality as stable as possible at both levels frame by frame and within the frame. The complexity of the previously encoded frame may be used to control the compression ratio for the current frame while using the previously allocated bits with a goal of remaining within the bit rate and latency constraints. This process also avoids having to use information from a future frame to encode the current frame, which may introduce additional latency.

Video compression methods for transmission use inter-frame prediction to reduce the amount of information required for transferring video data from the encoder to the decoder within the system. Scene changes, however, occur that introduce unexpected changes in the complexity of the current frame with regard to the previous frame.

A scene change also causes inaccurate inter-frame prediction of the first frame after it occurs. Thus, the rate control is impacted as demand for greater bit allocation is experienced, or possible latency problems result from the more complex encoding needed for the scene change. Conversely, if the bit rate is held constant and the latency kept at a minimum, then a very noticeable degradation of quality of the video signal may be experienced.

Video transmission systems, which may be supported over networks of devices, need to achieve a low end-to-end latency when supporting real-time video playback and interactive applications. High bit rate fluctuations, however, will result in video degradation when scene changes occur, and any technique requiring extra processing time, including the use of information available in the future, may not be used in these encoding processes.

### SUMMARY OF THE INVENTION

Embodiments of the present invention disclose a scene change detection process for a video transmission system that minimizes the quality degradation due to the presence of scene changes while not severely impacting the rate control for the system. The system detects and minimizes the degradation or possible latency and bit rate impacts by using different processes for the type of frames being transmitted in the system.

For inter-frame predicted image frames, the disclosed embodiments may use the percentage of intra-frame predicted macroblocks used for encoding the current image. For intra-frame predicted image frames, the disclosed embodiments may compare the compression ratio used on the current frame with the previous intra-frame predicted image frame. Thus, both types of image frames are handled by the disclosed embodiments for detecting a scene change within a video transmission.

The disclosed embodiments also may use bits reallocation and special compression ratio management to minimize the quality degradation impact on the transmitted video where the buffer status allows. The disclosed embodiments update dynamically all the necessary statistics involved in the compression ratio setting for achieving the objectives of low latency, bit rate and video quality. The statistics may include the decided intra-frame prediction level for the current image frame and the compression ratio used from the rate control.

According to the preferred embodiments, a method for encoding a scene change within an image frame of a video transmission system is disclosed. The method includes determining whether the image frame is an intra-frame image frame or an inter-frame image frame. The method also includes detecting the scene change for the inter-frame image frame if a number of macroblocks within the image frame are intra-macroblocks. The method also includes detecting the scene change for the intra-frame image frame if an average compression level from the number of macroblocks exceeds a normal compression level. The method also includes implementing a new set of encoding parameters upon detection of the scene change.

Further according to the preferred embodiments, a method for detecting a scene change within an image frame is disclosed. The method includes determining an average compression level for encoding a set of macroblocks within the image frame. The method also includes detecting the scene change if the average compression level exceeds a threshold that corresponds to a normal compression level for the image frame. The method also includes implementing a new set of encoding parameters and updating reference thresholds for the image frame upon detection of the scene change.

Further according to the preferred embodiments, a method for encoding an image frame within a video transmission system is disclosed. The method includes receiving a set of macroblocks within the image frame. The method also includes detecting a scene change within the image frame by determining whether an average compression level for the set of macroblocks exceeds a normal compression level for the image frame or if a number of macroblocks within the set are intra-macroblocks. The method also includes implementing a new set of encoding parameters corresponding to the scene change for the image frame.

### BRIEF DESCRIPTION OF THE DRAWINGS

The accompanying drawings are included to provide further understanding of the invention and constitute a part of the specification. The drawings listed below illustrate embodiments of the invention and, together with the description, serve to explain the principles of the invention, as disclosed by the claims and their equivalents.

FIG. 1 illustrates a video transmission system for transmitting and receiving video signal data according to the disclosed embodiments.

FIG. 2 illustrates image frames of a video transmission according to the disclosed embodiments.

FIG. 3 illustrates a flowchart for detecting a scene change within the video transmission system according to the disclosed embodiments.

FIG. 4 illustrates a flowchart for managing a buffer within the video transmission system during the scene change according to the disclosed embodiments.

### DETAILED DESCRIPTION OF THE PREFERRED EMBODIMENTS

Aspects of the invention are disclosed in the accompanying description. Alternate embodiments of the present invention and their equivalents are devised without parting from the spirit or scope of the present invention. It should be noted that like elements disclosed below are indicated by like reference numbers in the drawings.

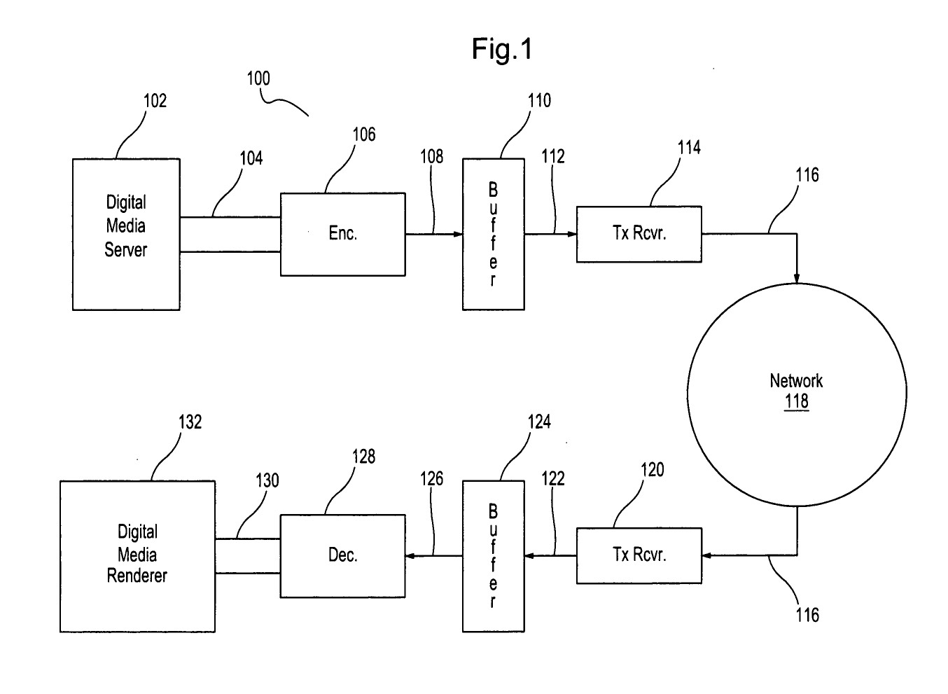

FIG. 1 depicts a system 100 for transmitting and receiving video signal data according to the disclosed embodiments. System 100 may be any system or collection of devices that connect over a network to share information. System 100, for example, may be a gaming system where video content is generated in the gaming console and then transmitted to a high-definition digital media renderer, such as a flat-screen television. Alternatively, system 100 may be a security monitoring system using high definition (HD) video.

Digital media server 102 generates the video content to be transmitted. Digital media server 102 may be any device, console, camera and the like that captures video data. The content generated from digital media server 102 is displayed for a user to view and interact with in real-time. Digital media server 102 may be a computer, video recorder, digital camera, gaming console, scanner and the like that captures data.

Uncompressed data signal 104 is output from digital media server 102 to encoder 106. Encoder 106 may encode or compress signal 104 for transmission within system 100. Encoder 106 may use a lossy compression technique to encode signal 104. The strength of such techniques (compression level) may change based on the complexity of the data within signal 104. For example, video data of a character in a game swinging a sword against an opponent is more complex, or very busy, than video of the character merely standing and could require different encoding processes to keep similar quality.

The video data is comprised of images that are encoded for transmission. The images include pixels that can be encoded to represent information within the pixel, such as color, luminance and motion. This information is transmitted and reconstructed. As noted above, a scene change within the images results in a change in this information as a pixel from one frame will be different in the subsequent frame.

Encoder 106 outputs compressed signal 108 to buffer 110. Buffer 110 stores data from signal 108 until it can be transmitted through system 100. If the network bit rate does not allow transmission of signal 108, then buffer 110 holds the data until such time it can be transmitted by transceiver 114. Buffer 110 outputs signal 112 to transceiver 114.

Transceiver 114 transmits signal 116 over network 118. Using the gaming example from above, network 118 may be a wireless network for a location where a router receives signal 116 from digital media server 102 and forwards it to digital media renderer 132 for display. Alternatively, network 118 may be a network of computers receiving signal 116 from a remote camera showing real-time video.

Transceiver 120 receives signal 116 and outputs signal 122 to buffer 124. Signal 126 streams from buffer 110 to decoder 128. Decoder 128 decodes or decompresses signal 126 to generate uncompressed signal 130. The information representing the pixels of the current image is used to reconstruct the image. Some information, however, may be lost during this process. Uncompressed signal 130 preferably is a high quality copy of uncompressed signal 104, which slight variations due to the coding process.

Digital media renderer 132 receives uncompressed signal 130 and displays the video data content to the user. Digital media renderer 132 may be a high-definition television having display resolutions of 1,280×720 pixels (720 p) or 1,920×1,080 pixels (1080 i/1080 p). Thus, the amount of data encoded and decoded within system 100 may be complex due to the demands place on it by digital media server 102 and digital media renderer 132.

System 100 is subject to various constraints and parameters. System 100 may transmit over network 118 at a constant bit rate. This bit rate remains the same over time, but, however, may change under certain circumstances. A delay or integration time may occur as buffer 110 fills up, which causes latency within system 100 as data is sent over network 118.

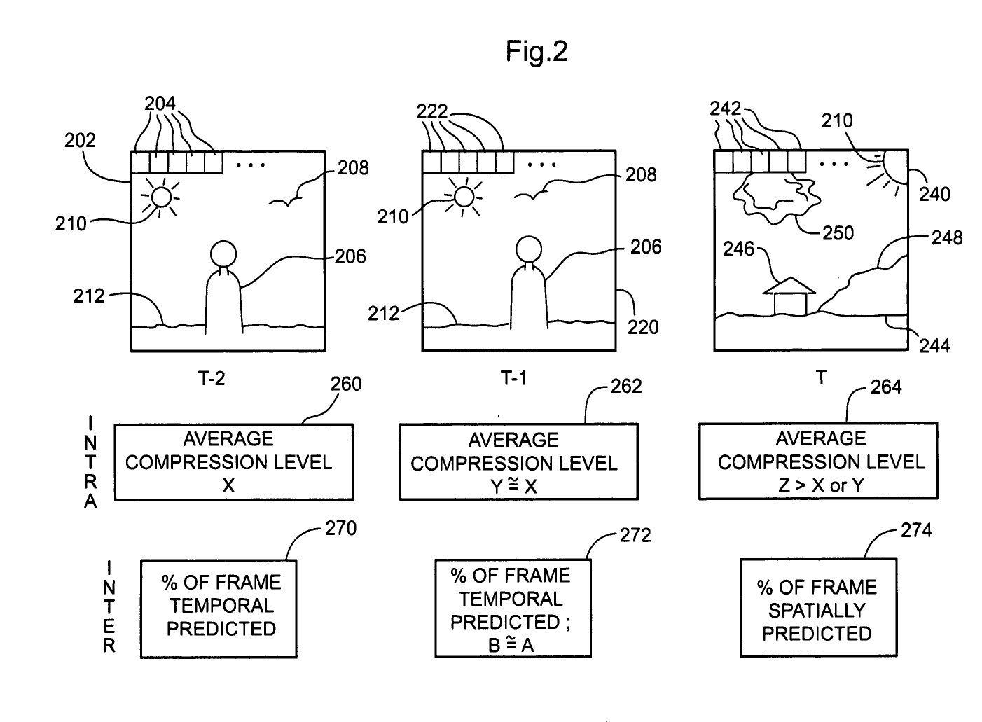

FIG. 2 depicts image frames 202, 220 and 240 of a video transmission according to the disclosed embodiments. In the sequence of images shown, frame 240 represents a scene change at time T. Frame 202 occurs at time T-2, or two frames prior to frame 240. If video transmission system 100 transmits 60 frames per second, then T-2 may represent the frame 2/60ths of a second before T. Frame 220 occurs at time T-1. Additional frames may occur prior to time T.

Frame 202 includes macroblocks 204. A macroblock may be a collection of pixels in an array, such as 8×8 or 16×16, that represents a location within frame 202. Encoder 106 encodes or compresses macroblocks 204 into digital information for transmission. Macroblocks are not necessarily identical but groups of macroblocks may be similar in information.

For example, frame 202 may include person 206, bird 208 and sun 210. Frame 202 also may have a horizon 212 in the background. Macroblocks representing the image of person 206 may differ from those for sun 210. Moreover, bird 208 may be flying so that its macroblocks may include a motion vector in its information.

Frame 220 is similar to frame 202 in that person 206 and sun 210 do not move significantly. Thus, encoder 106 may predict the information for macroblocks 222 of frame 220 by using information for macroblocks 204. Horizon 212 also stays steady in frame 220. The only difference may be the position of bird 208. The disclosed embodiments may use inter-frame prediction for frame 220 in that the predicted values for macroblocks 222 rely on a previous frame, but also use spatial prediction for those macroblocks 222 representing bird 208. Spatial prediction may use macroblocks 222 within frame 220 as opposed to previous macroblocks in frame 202.

Frame 240 includes many differences from frames 202 and 220. For example, person 206 is removed from the image as well as bird 2208. Sun 210 changes position within frame 240 as well as size. Frame 240 also includes structure 246, hillside 248 and clouds 250. Horizon 244 of frame 240 may not correspond to the location of horizon 212 in frames 202 and 220. Thus, macroblocks 242 may differ significantly from macroblocks 204 and 222. A few macroblocks 242 may be predicted from the information in the previous frames, but a large percentage will need to be encoded. Thus, the workload placed on system 100 will increase to meet the complexity of the information due to the scene change.

For intra-frame prediction, blocks 260, 262 and 264 may represent parameters or statistics pertaining to the respective frames 202, 220 and 240. Intra-frame prediction is applicable in those instances where previous image frame information is not used or available. All macroblocks within an intra-frame image frame are intra-macroblocks in that they do not depend on previous frame's macroblock information in predicting its values.

Statistic 260 indicates that the average compression level for macroblocks 204 is “X.” X may represent a number corresponding to a standard level for compression, such a number between 0 and 12. A compression level of 0 may indicate no compression is performed, such as when frame 202 and 220 are completely identical. A compression level of 1 may indicate minimum encoding was done, and due to the predicted macroblocks, the bit rate needed to transmit the information is acceptable. A compression level of 12, however, may indicate a complex compression where the bits needed for compression increases significantly, such as when the macroblocks differ greatly from each other within the image. Other numbers and designations may be used for compression levels.

The average compression level X, therefore, represents an average number for all the compression level numbers of macroblocks 204 of frame 202. Statistic 262 represents the average compression level Y for macroblocks 222 of frame 220. Because frame 202 and 220 are similar, average compression level Y is approximately equal to average compression level X. The disclosed embodiments may set an acceptable variance between statistics 260 and 262 to show that a scene change does not occur, such plus or minus 10%.

Statistic 264 represents the average compression level Z for macroblocks 242 of frame 240. Because of the scene change, the average compression level Z should be greater than average compression level X or Y. Macroblocks 242 require more information for encoding. Frame 240 may represent a lot of action or motion that prevents spatial prediction of macroblocks 242.

Thus, the disclosed embodiments may examine a set of macroblocks 242 as frame 240 arrives at encoder 106 to see if the average compression levels differ, and a scene change is imminent. The unexpected increase of the average compression level for the scene change within frame 240 may cause unexpected consumption of bits or significant quality variation. A timely detection may minimize the impact to both of these.

Statistics 270, 272 and 274 may represent parameters or statistics pertaining to the respective frames 202, 220 and 240 during inter-frame prediction. Inter-frame prediction relies upon the information from previous frames to alleviate encoding demands. Thus, inter-frame prediction may use temporal prediction as well as spatial prediction. To determine a scene change, the disclosed embodiments may examine the percentage of macroblocks within the frame able to be predicted using temporal prediction to determine whether a scene change is occurring.

Statistic 270 represents a percentage of macroblocks 204 within frame 202 that are temporally predicted. In other words, a number of macroblocks of the total number of macroblocks 204 are inter-macroblocks within frame 202. For example, for inter-frame prediction, if 90% of macroblocks 204 are predicted using temporal, or previous, information, then no scene change occurs.

Statistic 272 represents a percentage of macroblocks 222 within frame 220 that are temporally predicted, or the number of macroblocks of the total number of macroblocks 22 that are inter-macroblocks. Because no significant changes occur between frames 270 and 272, the percentages should be about equal.

Statistic 274 represents a percentage of macroblocks 242 within frame 240 that are spatially predicted. Because frame 240 includes a scene change, the percentage of temporally predicted macroblocks is minimal, so a greater percentage of macroblocks 242 are intra-macroblocks. A comparison of statistic 274 to statistics 270 or 272 indicates that a change occurred at time T. The percentages for frame 240 are not in accordance with the other percentages for frames 202 and 220. An unexpected percentage of spatial predictions during the encoding process by encoder 106 of frame 240 may cause unexpected consumption of bits or degradation of quality due to the scene change.

Thus, due to the scene change in frame 240, various statistics will indicate such a change. Using these statistics for a frame during encoding allows the disclosed embodiments to detect a scene change. After detection, the rate control, bit rate, buffer allocation and the like may be adjusted to provide a quality video transmission without significant end-to-end latency.

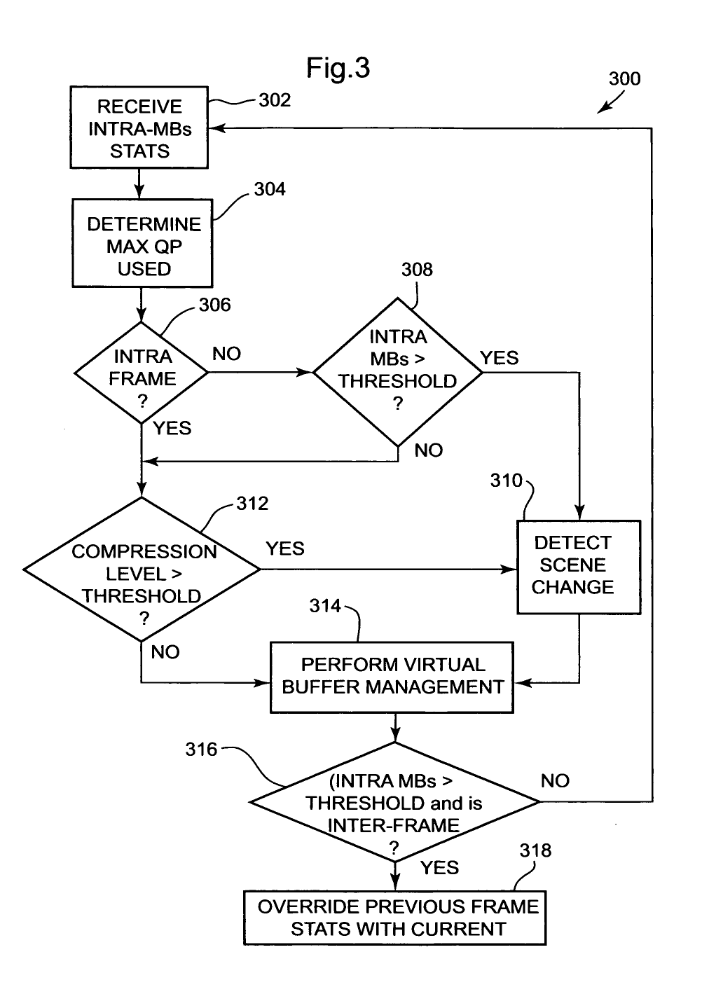

FIG. 3 depicts a flowchart 300 for detecting a scene change within video transmission system 100 according to the disclosed embodiments. Step 302 executes by receiving intra-macroblock statistics, such as statistic 264 for the average compression level for macroblocks within the image frame. Step 304 executes by determining the maximum compression level being used for use in subsequent operations, as disclosed below.

Step 306 executes by determining whether the current frame, such as frame 240, is an intra-frame. If step 306 is no, then the current frame is an inter-frame that may be using temporal prediction, preferably. Thus, step 308 executes by determining whether the intra-macroblocks for the current frame exceed a threshold set by system 100. In other words, step 308 determines whether the percentage of macroblocks that are intra-macroblocks, or spatially predicted, exceed a threshold set to indicate a scene change. For example, this threshold may be 40% of macroblocks are intra-macroblocks. If step 308 is yes, then step 310 is executed. Step 310 is disclosed in greater detail below.

If step 306 is yes, then the current frame is an intra-frame. An intra-frame indicates that macroblock prediction is done by spatial prediction, and not temporal prediction. Moreover, if step 308 is no, then flowchart 300 goes to step 312. Step 312 executes by determining whether the compression level exceeds a threshold. As shown by statistics 260-64, the average compression level should remain steady between frames that do not include a scene change. An increase in the average compression level indicates a possible scene change, such as in frame 240.

Thus, step 312 determines whether the compression level determined in step 304 for the macroblocks within the current frame is above a threshold for the average compression level. This threshold may be set by system 100. When the disclosed embodiments determine that the compression level is much higher than the normal circumstances, as shown by the threshold, a scene change may have occurred. For example, if the compression levels are between 1 and 12, then an average compression level above 7 may indicate a scene change.

If step 312 is yes, then step 310 executes by detecting a scene change within the current frame. Further, step 310 may implement new rate control parameters to accommodate the scene change, such as adjusting bit allocation or other remedial measures. In step 314 below, a scene change results in overriding a number of encoding parameters. The disclosed embodiments, for example, may use two sets of values for encoding parameters. A set of normal values are used for non-scene change cases and another set of values that are used when a scene change is detected. Encoder 106 is alerted of the scene change, and buffer available bits may be reallocated.

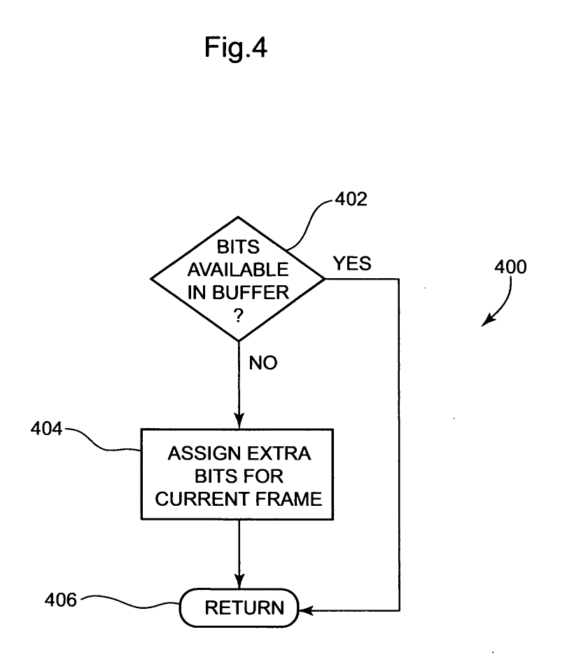

Step 314 executes by performing virtual buffer management and overriding a number of encoding parameters. As disclosed above, the disclosed embodiments may override the normal set of encoding parameters with another set that pertains to scene change conditions. This step is disclosed in greater detail by FIG. 4. Virtual buffer management allows the rate control to allocate more bits in buffer 110, if available, to handle the increased complexity of the encoded data caused by the scene change.

Step 316 executes by determining whether the intra-macroblocks within the current frame is above another threshold and if the current frame is an inter-frame image frame. If no, then flowchart 300 returns to step 302 for the next frame. If step 316 is yes, then step 318 executes by overriding the statistics of the previous frame with the statistics of the current frame, and overriding a number of encoding parameters. This step allows the subsequent frames to be compared to the current frame so as to identify further scene changes.

Thus, the disclosed embodiments enable scene change detection at the macroblock level. Further, the disclosed embodiments are not limited to one prediction scheme, but can operate with temporal and spatial prediction schemes. The disclosed embodiments also may work with intra-macroblocks as well as inter-macroblocks. The statistics for these macroblocks are gathered and compared to identify a scene change so that encoder 106 may take action to accommodate any bit rate fluctuations or prevent latency from creeping into system 100.

The analysis performed in steps 308 and 312 may be performed for each macroblock as it is encoded such that the scene change may be detected at any time. Preferably, several macroblocks are encoded prior to doing the analysis to gather enough data for average compression level of the current frame and a certain number of macroblocks. However, once the thresholds are exceeded, then the scene change is detected, and step 310 executed.

FIG. 4 depicts a flowchart 400 for managing a buffer within video transmission system 100 according to the disclosed embodiments. Flowchart 400 may relate back to step 314 of FIG. 3, and is executed primarily when a scene change is detected. Step 314, however, may be executed when a scene change is not detected to allow the disclosed embodiments the ability to manage the buffer status.

Step 402 executes by determining whether enough bits are available in the buffer, such as buffer 110, to encode the current frame. The increase in complexity of the data due to a scene change may result in a bit rate fluctuation that fills or possibly spills over buffer 110. Because the current frame cannot reliably depend on temporal or spatial prediction to reduce data complexity, the new data generated by the scene change is encoded or compressed using the algorithms to capture all the data for the macroblocks within the frame.

If step 402 is yes, then enough bits are available, and flowchart 400 goes to step 406. Step 406 returns back to the previous flowchart for further operations. If step 402 is no, then step 404 executes by assigning extra bits for the current frame so that the increased data complexity is handled. Step 404 also may override a number of encoding parameters. Step 404 may assign bits reserved for a subsequent frame or may increase the size of the virtual buffer to accommodate the bits. For example, encoder 106 may assign 10% more bits for encoding the current frame to prevent latency within system 100 and degradation in video quality. Step 406 then returns back to the previous flowchart for further operations.

Other new encoding parameters also may be used to encode the image frame having a scene change. The new encoding parameters may allow system 100 to handle the increased complexity due to the scene change without noticeable decrease in video quality or latency within system 100.

It will be apparent to those skilled in the art that various modifications and variations may be made in the disclosed embodiments of the privacy card cover without departing from the spirit or scope of the invention. Thus, it is intended that the present invention covers the modifications and variations of the embodiments disclosed above provided that the modifications and variations come within the scope of any claims and their equivalents.

What is claimed is:

1. A method for encoding a scene change within an image frame of a video transmission system, the method comprising:
determining whether the image frame is an intra-frame image frame or an inter-frame image frame;
detecting the scene change for the inter-frame image frame if a number of macroblocks within the image frame are intra-macroblocks;
detecting the scene change for the intra-frame image frame if an average compression level from the number of macroblocks exceeds a normal compression level; and
implementing a new set of encoding parameters upon detection of the scene change.

2. The method of claim 1, further comprising determining a maximum compression level, which corresponds to a top limit for compression level within the image frame.

3. The method of claim 1, further comprising also detecting the scene change for the inter-frame image frame if the average compression level from the number of macroblocks exceeds a normal compression level.

4. The method of claim 1, wherein the new set of encoding parameters includes a bit rate.

5. The method claim 1, wherein the step of implementing the new set of encoding parameters includes assigning extra bits to encode the image frame.

6. The method of claim 1, further comprising receiving statistics for a number of intra-macroblocks within a previous image frame.

7. The method of claim 6, wherein the detecting the scene change for the inter-frame image frame step includes determining whether the number of intra-macroblocks for the image frame exceeds the statistics for the number intra-macroblocks within the previous image frame.

8. The method of claim 6, further comprising overriding the statistics for the previous image frame with statistics for the image frame.

9. A method for detecting a scene change within an image frame, the method comprising:
determining an average compression level for encoding a set of macroblocks within the image frame;
detecting the scene change if the average compression level exceeds a threshold that corresponds to a normal compression level for the image frame; and
implementing a new set of encoding parameters for the image frame upon detection of the scene change.

10. The method of claim 9, further comprising detecting the scene change if a number of macroblocks with the set of macroblocks are intra-macroblocks.

11. The method of claim 9, further comprising determining whether enough bits are available in a buffer to accommodate the new set of encoding parameters.

12. The method of claim 11, further comprising assigning extra bits to encode the image frame.

13. A method for encoding an image frame within a video transmission system, the method comprising:
receiving a set of macroblocks within the image frame;
detecting a scene change within the image frame by determining whether an average compression level for the set of macroblocks exceeds a normal compression level for the image frame or if a number of macroblocks within the set are intra-macroblocks; and
implementing a new set of encoding parameters corresponding to the scene change for the image frame.

14. The method of claim 13, further comprising performing virtual buffer management based on the detecting step.

15. The method of claim 13, further comprising determining whether the image frame is an inter-frame image frame.

16. The method of claim 13, further comprising encoding a remaining set of macroblocks from the image frame according to the new set of encoding parameters.

17. The method of claim 13, further comprising determining whether enough bits are within a buffer to accommodate the new set of encoding parameters.

18. The method of claim 17, further comprising assigning a number of extra bits if the determining steps indicates not enough bits are within the buffer.

19. The method of claim 1, further comprising updating a reference threshold for the number of macroblocks.

20. The method of claim 1, further comprising updating a reference threshold for the normal compression level.
